(19) United States
(12) Patent Application Publication
(10) Pub. No.: US 2004/0183304 A1
(43) Pub. Date: Sep. 23, 2004

(54) Watertight coupler

(75) Inventor: Tim Hsu, Taipei (TW)

Correspondence Address: BRUCE H. TROXELL, SUITE 1404, 5205 LEESBURG PIKE, FALLS CHURCH, VA, 22041, US

(73) Assignee: Steel Dragon Enterprise Co., Ltd.

(21) Appl. No.: 10/392,911

(22) Filed: Mar. 21, 2003

(51) Int. Cl. F16L 17/00

(52) U.S. Cl. 285/373

(57) ABSTRACT

A watertight coupler, of which the watertight structure is firm and reliable to make the coupler able to fast and conveniently connect two mutually opposite water pipes. The watertight coupler comprises a main body with a specific axial length; the main body of the coupler has an inner bore in coincident with the external diameters of pipes to be connected, and is provided on the inner wall thereof with a diametrically extending stop means for connecting pipe ends of the pipes to be connected; a hollow annular water-sealing gasket preferably made of waterproof material which makes it more pressed in water when it is assembled normally is connected with the stop means of the main body of the coupler in advance; the pipes to be connected are mutually opposite and are then extended with their partial lengths into the main body of the coupler having a water-sealing gasket assembled thereon for connecting therewith, so that the mutually opposite end faces of the pipes are tightly pressed against the water-sealing gasket.

### BACKGROUND OF THE INVENTION

1. Field of the invention

The present invention is related to a watertight coupler, and especially to a watertight coupler of which the watertight structure is firm and reliable to make the coupler able to fast and conveniently connect two mutually opposite water pipes.

2. Description of the Prior Art

In a conventional pipe connecting operation, such as laying sewers or telecommunication pipes, generally, watertight structures must be provided between every two mutually opposite pipe ends of the pipe components to prevent leakage or permeation of humidity.

Taking a pipe to be connected made of PE as an example, the wall of the connected pipe, especially of a usually seen smooth pipe, shall generally be of a specific thickness to endue the pipe with sufficient compression strength. When it is used in connecting the smooth pipes such as the abovementioned sewers or telecommunication pipes, the way to form the watertight state between the mutually opposite pipe ends generally is heat-melting end connecting. However, such way of processing must have heat-melting equipment bought and moved to the site of working in advance; this not only increases the cost, but also is inconvenient and time consuming by virtue that it must do the heat-melting end connecting work for every couple of mutually opposite pipe ends.

When a wavy pipe is used for pipeline connection, it has an advantage of saving material for pipe connecting with a corresponding strength and can directly form a watertight means by insertion fitting using a corresponding leakage-proof structure between the coupler and the two pipe ends. The most usual mode in such a structural designing is that the pipe ends of the pipes to be connected are provided with leakage-proof rings, in order that the plastic rings are press combined with the inner wall of the coupler to get the water sealing function. Nevertheless, the watertight connecting structure is subjected to deformation by that the pressure it bears is larger than the bearing strength set for it after laying of the pipeline, and thereby the original watertight effect is lost.

### SUMMARY OF THE INVENTION

The object of the present invention is to provide a watertight coupler of which the watertight structure is firm and reliable to make the coupler able to fast and conveniently connect two mutually opposite water pipes.

To obtain the object, the present invention is provided with a main body of the coupler with a specific axial length, the main body of the coupler has an inner bore in coincident with the external diameters of pipes to be connected, and is provided near the middle thereof with a recess recessed diametrically and having a set depth to be used as a stop means for pipe ends; a hollow annular water-sealing gasket is provided having a sectional area of its own main body in corresponding with the shape of the sectional area of the recess of the main body of the coupler and having two lateral skirt portions for the purposed of connecting the water-sealing gasket with the main body of the coupler in advance; two mutually opposite pipes to be connected can be extended with their partial lengths into the main body of the coupler having the connected water-sealing gasket assembled thereon for connecting therewith, so that the mutually opposite end faces of the pipes are tightly pressed against the two lateral skirt portions of the water-sealing gasket.

In a preferred embodiment, the water-sealing gasket had better be made of waterproof material which makes it more pressed in water when it is assembled normally.

In a practicable embodiment, the water-sealing gasket can be divided and provided on the aforementioned stop means in the coupler and respectively at the two pipe ends of the two mutually opposite pipes to be connected.

The present invention will be apparent after reading the detailed description of the preferred embodiment thereof in reference to the accompanying drawings.

### BRIEF DESCRIPTION OF THE DRAWINGS

FIG. 1 is a partial sectional perspective view showing a preferred embodiment of the present invention;

FIG. 2 is an exploded view showing the main body of the coupler and the water-sealing gasket of FIG. 1;

FIG. 3 is an exploded view of the two mutually opposite pipes to be connected with the members of FIG. 2;

FIG. 4 is a sectional view showing the state of combination of the members in FIG. 3;

FIG. 5 is a sectional view showing the state of combination of another practicable embodiment of the present invention.

### DETAILED DESCRIPTION OF THE PREFERRED EMBODIMENT

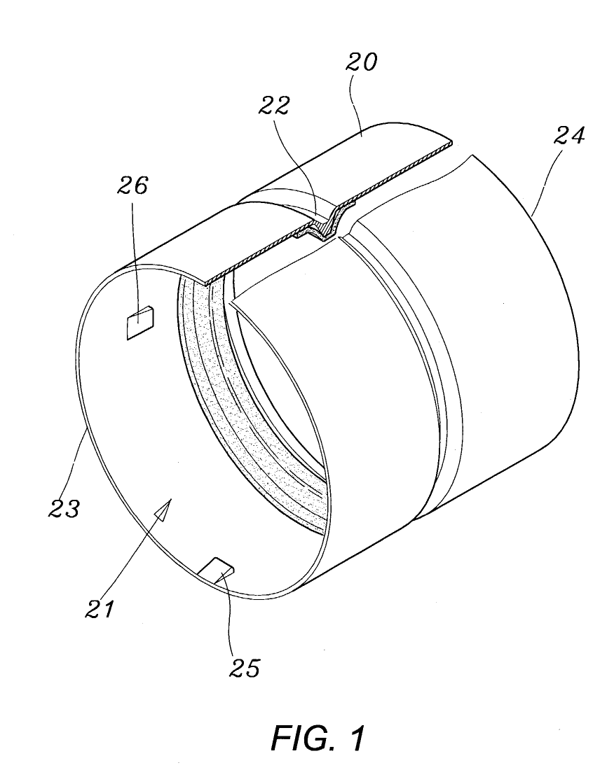

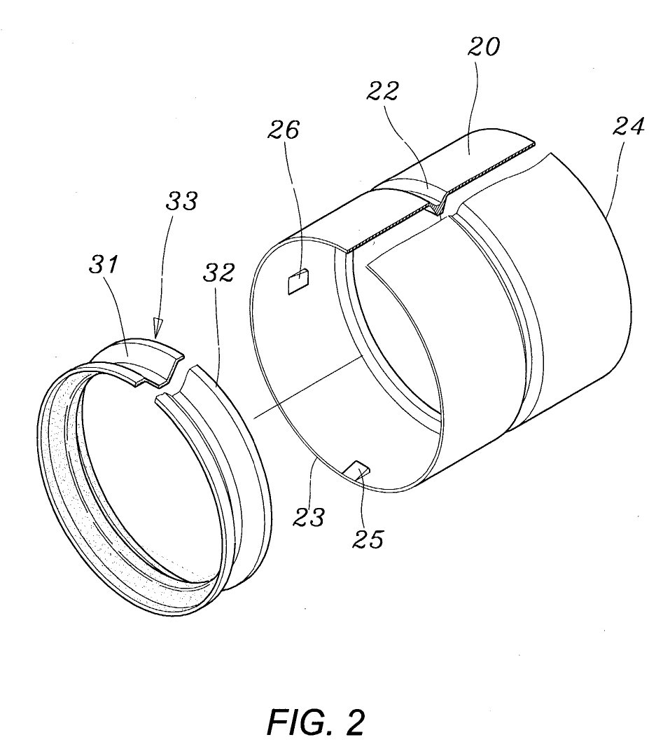

Referring to FIGS. 1 and 2, the present invention is provided with a main body 20 of the coupler with a specific axial length, the main body 20 of the coupler has an inner bore 21 in coincident with the external diameters of pipes to be connected, and is provided near the middle thereof with a recess 22 recessed diametrically and having a set depth to be used as a positioning stop means for pipe ends. This embodiment is only used as an example for illustration, in this practicable embodiment, the positioning stop means of the pipe ends of the pipes to be connected can also be formed by providing a ring with flanges on the inner wall of the main body 20 of the coupler in some other way.

A water-sealing gasket 30 most preferably made of waterproof material which makes it more pressed in water when it is assembled normally can be mounted on the positioning stop means (the recess 22 as shown) assembled on the pipe ends of the pipes (to be connected) fitted in the inner wall of the main body 20 of the coupler.

In the embodiment shown, the main body 20 of the coupler is provided at the slightly inner spots from the two end faces 23, 24 thereof with engaging members 25, 26. In this preferred embodiment, the engaging members 25, 26 are embedded blocks with triangular sectional areas; they are arranged slightly staggered axially from each other to get an effect of hooking engagement. In other words, the engaging members 25 are located nearer to the two end faces 23, 24 respectively; while the engaging members 26 are located nearer to the middle water-sealing gasket 30.

In the preferred embodiment, the water-sealing gasket 30 is a hollow ring; it has a sectional area of its own main body in corresponding with the shape of the sectional area of the recess 22 of the main body 20 of the coupler, and has two lateral skirt portions 31, 32. In the embodiment shown, the back side 33 of the water-sealing gasket 30 can be connected with glue in advance to the opposite surface on the recess 22 of the main body 20 of the coupler to be ready for connecting the pipes.

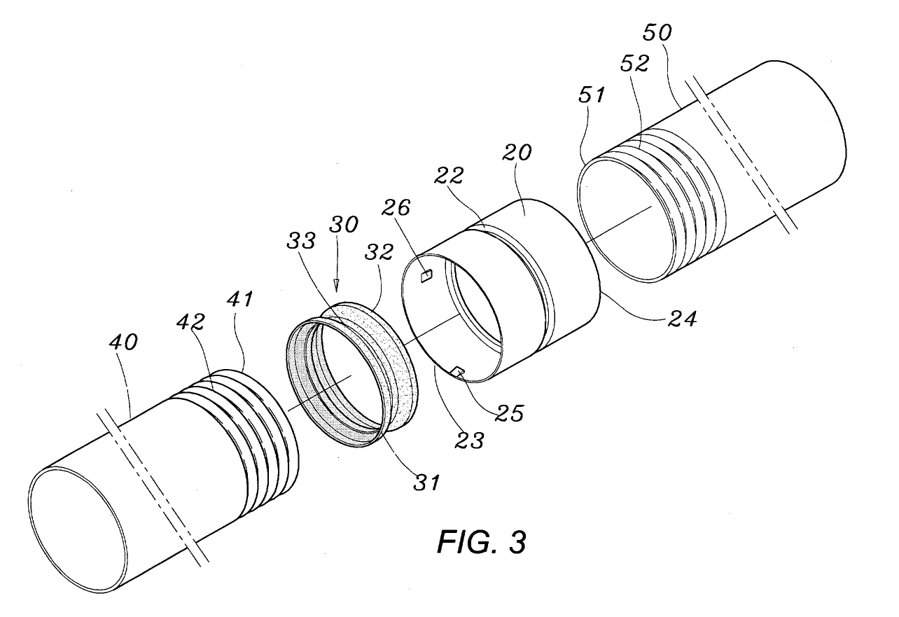

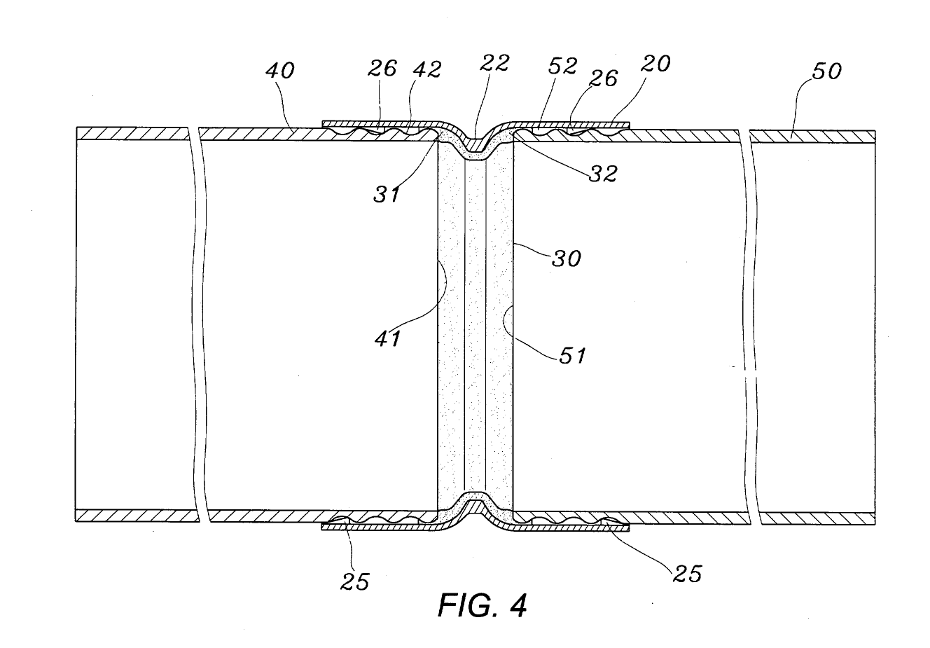

As shown in FIGS. 3, 4, two mutually opposite pipes 40, 50 to be connected (the pipes to be connected in this embodiment are wavy pipes) can have partial lengths thereof extended into the main body 20 of the coupler already connected with the water-sealing gasket 30 to render the two mutually opposite pipe ends 41, 51 respectively of them to be tightly press connected with the two lateral skirt portions 31, 32 of the water-sealing gasket 30 to complete the pipe connecting work.

In the embodiment shown, in cooperation with the engaging members 25, 26 provided at the slightly inner spots from the two end faces 23, 24 of the main body 20, the pipes 40, 50 to be connected can be provided on the mutually opposite external peripheral surfaces of the extended-in ends thereof with continuous wavy portions 42, 52. So that during insertion connecting of the two pipes 40, 50, the continuous wavy portions 42, 52 will gradually pass through the engaging members 25, 26 with triangular sectional areas and are hooking engaged in position, the engaging mechanism can prevent the two pipes 40, 50 from being loosened by external pulling forces.

After connecting and positioning of the two pipes 40, 50 and the main body 20 of the coupler, the two mutually opposite pipe ends 41, 51 of the pipes 40, 50 press the two lateral skirt portions 31, 32 of the water-sealing gasket 30 to make them get closer to the recess 22 of the main body 20; they form an extremely tight and reliable watertight structure to effectively prevent water from leaking outwardly from the joint of the two pipes 40, 50 or prevent external water from permeating.

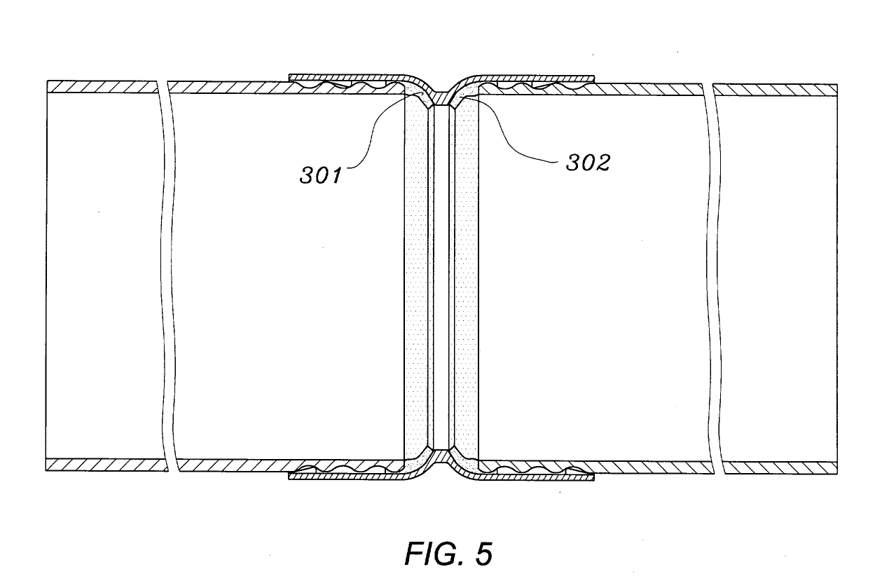

In another practicable embodiment shown in FIG. 5, the water-sealing gasket can be divided into individual pieces 301, 302 and provided on the a stop means in the aforementioned coupler and face to the two pipe ends of the two mutually opposite pipes to be connected respectively.

The present invention can get an effective watertight with the above stated improved structure, and the two pipes to be connected can be extended with their partial lengths into the coupler having the connected water-sealing gasket assembled thereon, and the operation of pipe connecting can thus be completed, this is fast and convenient and surely endued with industrial value.

The preferred embodiments are only for illustrating and not for giving any limitation to the scope of the present invention. It will be apparent to those skilled in this art that various modifications or changes made to the elements of the present invention without departing from the spirit thereof shall fall within the scope of the appended claims.

1. A watertight coupler, said coupler is provided with a main body with a specific axial length, said main body of said coupler has an inner bore in coincident with the external diameters of pipes to be connected, and is provided on the inner wall thereof with a diametrically extending stop means for connecting pipe ends of said pipes to be connected; a hollow annular water-sealing gasket is connected with said stop means of said main body of said coupler in advance; said pipes to be connected are mutually opposite and are then extended with their partial lengths into said main body of said coupler having a water-sealing gasket assembled thereon for connecting therewith, so that the mutually opposite end faces of said pipes are tightly pressed against said water-sealing gasket.

2. The watertight coupler as claimed in claim 1, wherein
said stop means is formed from a recess provided near the middle of said main body and recessed diametrically and having a set depth.

3. The watertight coupler as claimed in claim 1, wherein
said water-sealing gasket has a sectional area of its own main body in corresponding with the shape of the sectional area of said stop means of said main body of said coupler and has two lateral skirt portions.

4. The watertight coupler as claimed in claim 1, wherein
said water-sealing gasket is divided into individual pieces and provided on the said stop means in said coupler and respectively at said two pipe ends of said two mutually opposite pipes to be connected.

5. The watertight coupler as claimed in claim 1, wherein
said main body of said coupler is provided at slightly inner spots from two end faces thereof with engaging members for connecting and positioning of said two mutually opposite pipes to be connected.

6. The watertight coupler as claimed in claim 5, wherein
said engaging members are embedded blocks with triangular sectional areas, and are arranged slightly staggered axially from each other for connecting continuous wavy portions provided on mutually opposite external peripheral surfaces of extended-in ends of said pipes to be connected.
